(19) United States
(12) Patent Application Publication
(10) Pub. No.: US 2011/0100071 A1
(43) Pub. Date: May 5, 2011

(54) Filter Unit for Household Appliance

(75) Inventors: Gianfranco MAZZON, Porcia (IT); Fabio POLONI, Porcia (IT); Daniele FAVARO, Porcia (IT)

(73) Assignee: ELECTROLUX HOME PRODUCTS CORPORATION N.V., Zaventem (BE)

(21) Appl. No.: 12/914,349

(22) Filed: Oct. 28, 2010

(30) Foreign Application Priority Data
Oct. 29, 2009 (EP) 09013608.6

(51) Int. Cl. D06F 37/00; C02F 1/00; B01D 35/02

(52) U.S. Cl. 68/208; 210/171

(57) ABSTRACT

A filter unit (1, 1a) is provided for, and/or as part of, a household appliance, in particular a washing machine. The filter unit includes a filter receiving body (2), a filter opening (30) in the filter receiving body (2), and a cap (3) for closing the filter opening. A drain passage (4) passes through the cap (3), and a closing means (5) is provided for closing the drain passage (4). A swivel-mounted lever element (6) is provided in operative connection with the closing means (5) for opening and closing the closing means.

### CROSS-REFERENCE TO RELATED APPLICATION

This application claims priority under 35 U.S.C. §119 to European Application No. EP09013608.6, filed Oct. 29, 2009.

### BACKGROUND OF THE INVENTION

The invention relates to a household appliance, in particular a washing machine, having a water draining and/or circulation unit in which a filter is installed upstream a pump.

DE 1 585 818 A discloses a fluff filter unit for a washing machine that is provided upstream a draining pump. The fluff filter is arranged at the lower end of the washing machine and is pivotably mounted on a knurled screw cap by which a front drain opening of the fluff filter unit is closed. The front drain opening represents a main drain path and below the front drain opening a smaller auxiliary drain opening is provided which is covered by a small screw cap. The auxiliary drain opening is connected via a channel to the main volume of the fluff filter unit in which the fluff filter is located when the knurled screw cap is closed. The small screw cap locks the knurled screw cap in its closed position and has to be removed first before unscrewing the knurled screw cap. Thereby residual liquid flows out of the fluff filter unit through the auxiliary drain opening before the fluff filter is taken out.

In EP 1 881 101 A1 another filter unit for a washing machine is suggested in which the main drain opening is covered by a cap. The cap is connected to the filter unit by a bayonet lock and supports the fluff filter that can be taken out of the fluff filter unit by the cap. The user can hold and turn the cap at a grip thereof. A small cap is arranged at the front and lower side of the cap when it is in its locked position. When the small cap is removed it opens a drain pipe passing through the cap and residual water in the fluff filter unit can discharge through the drain pipe with a correspondingly small flow rate.

### SUMMARY OF INVENTIVE ASPECTS

It is an object of the invention to provide a filter unit and a household appliance having such a filter unit, which allows an easy and convenient draining of residual liquid.

In an aspect, the invention is directed to a filter unit for a household appliance, e.g. a washing machine or a washer-dryer. The filter unit comprises a filter receiving body, a filter opening in the filter receiving body and a cap for closing the filter opening in the receiving body. The cap comprises a drain passage which passes through the cap and a closing means for closing the drain passage in the cap. Further, a swivel-mounted lever element is in permanent connection or operative connection with the closing means adapted to open and close the drain passage by the closing means.

For draining water out of the filter unit, the swivel-mounted lever element is opened and the closing means is opening the drain passage such that residual water flows through the drain passage of the cap out of the filter unit. User convenience is improved because the opening (and preferably closing) of the drain passage is made by operating the lever element and thereby actuating the closing means: no multiple-turn rotation of a threaded small cap is required. After the water has been drained, for example into a container provided by a user, the cap itself can be opened and removed to clean the filter unit from fluff, lint or other small objects (i.e. buttons, coins, etc). Preferably, but not necessarily, before the cap is opened, the drain passage in the cap may be closed again by the swivel-mounted lever element.

Preferably, the lever element comprises a drain channel. The drain channel guides water away from the filter unit, in particular in the opened position of the lever element. Thereby the flow direction of water flowing out of the filter unit can be precisely controlled.

In a preferred embodiment, the cap comprises a handle element, in particular a handle element having lateral wings. The handle element at least partially encloses the lever element, in particular in the closed position of the lever element. Preferably the handle element is provided with wing portions that laterally enclose the lever element in its closed position. The handle element or grip may be used to rotate the cap into an opened or closed position. Thereby the handle element of the cap can be conveniently used also in an opened position of the lever element for handling the cap and the filter. When the handle element is provided by the lever element itself fewer components are required and compact design is achieved.

Alternatively, the lever element is formed as a handle element and may be used to open and close the cap, in particular when the lever element is in a closed position.

Preferably, the closing means is pivotable mounted. In particular the lever element and the closing means have a common pivot bearing, in particular a pivot axis, that is arranged at the closing means or at the lever.

In a preferred embodiment, the filter unit comprises a filter element which is received in the filter receiving body, wherein the filter element is rotatably attached to the cap. Thereby the cap may be rotated while the filter element, e.g. sieve, remains stationary. A filter element can comprise a sieve or fine mesh for catching fluff, lint and small objects like coins.

Alternatively, the filter element and the cap are integrally formed, i.e. they are one-piece. Thereby the number of pieces of the filter unit is reduced, whereby the assembly of a filter unit is facilitated.

According to a preferred embodiment, the closing means forms a valve element in respect of the drain passage of the cap, preferably a ball valve element or butterfly valve element. In particular, the valve element is not encapsulated in a valve body. Additionally or alternatively, the valve element is arranged at the outer opening of the drain passage in the cap.

Preferably, the closing means comprises sealing means arranged at the cap. For example, an O-ring which is attached to the cap to provide a water-tight seal for the valve, i.e. between the mating surfaces of the cap and the closing means.

According to a further embodiment, the closing means is arranged at a lever end of the lever element. By operating the lever element, the closing means is swung away from the drain passage of the cap for opening. In particular, the pivot axis or pivot bearing of the lever element is arranged in a middle region of the lever element and the actuation end of the lever element is opposite to the end where the closing means is arranged. In a further embodiment, the ratio of the lever distance between the end of the closing means and the pivot point, and the distance between the actuation end and the pivot point of the lever, is less than one such that the user convenience is improved by using the lever-effect for actuating the closing means via the lever element.

Preferably, the closing means comprises a plug which is at least partially pluggable to the drain passage of the cap. For example a conically tapered plug or cylindrical plug which is preferably made of a resilient material to form a water tight seal for the drain passage in the cap.

In a preferred embodiment, the closing means comprises a cover plate or disc to close the outlet of the drain passage in the cap. Alternatively the closing means comprises a combination of a plug and a plate to provide a secure closing of the drain passage in the cap.

According to a further embodiment, the filter unit comprises a second lever element which is operative as a lock element for the swivel-mounted lever element. The locking-function of the second lever element prevents an accidental activation of the swivel-mounted lever element, i.e. an opening of the drain passage of the cap. Preferably, the second lever element comprises a drain channel for guiding water away from the filter unit as described above. In a first step the second lever element is opened to provide a drain channel and in a second step the swivel-mounted lever element is gradually opened to drain residual water in a controlled manner. The amount of water flowing out of the drain passage can be precisely controlled by the opening degree of the drain passage.

When the lever or second lever is arranged diagonal at the front side of the cap in an embodiment, the turning operation when using the lever or second lever as a handle element is made easy for the user. Preferably, the pivot point of the lever or second lever is at lower portion of the cap when the cap is in its closed position at the filter unit.

Preferably, the second lever element forms a handle for the cap. Alternatively or additionally, the cap is provided with a handle element as described above, i.e. a handle element that laterally surrounds the second lever element and/or the swivel-mounted lever element to provide a convenient handle also when the second lever element is in an opened position.

According to another inventive aspect, a household appliance is provided having a filter unit as described above. Such a household appliance can be a front loading or top loading washing machine with or without a recirculation circuit, as well as a washer-dryer, i.e. a combination of a washing machine and a tumble dryer.

### BRIEF DESCRIPTION OF THE DRAWINGS

Reference is made in detail to preferred embodiments of the invention, examples of which are illustrated in the accompanying figures, which show:

FIG. 1 a cross-sectional side-view of a filter unit according to a first embodiment of the invention, wherein the drain passage in the cap is closed,

FIG. 2 the filter unit of FIG. 1, wherein the drain passage is opened,

FIG. 3 a perspective view of the cap of the filter unit of FIG. 1,

FIG. 4 a perspective view of the cap of the filter unit of FIG. 1, wherein the drain passage is opened,

FIG. 5 an exploded view of the cap of FIG. 4,

FIG. 6 a cross-sectional side-view of a filter unit according to a second embodiment of the invention wherein a drain passage in the cap is closed,

FIG. 7 the filter unit of FIG. 6 in an intermediate opening state,

FIG. 8 the filter unit of FIG. 6, wherein the drain passage of the cap is opened, and

FIG. 9 an exploded view of the filter unit of FIG. 6 without the receiving body.

FIG. 10 is a schematic perspective view of a laundry washing machine including a filter unit as shown in the preceding figures.

### DETAILED DESCRIPTION OF EXAMPLE EMBODIMENTS

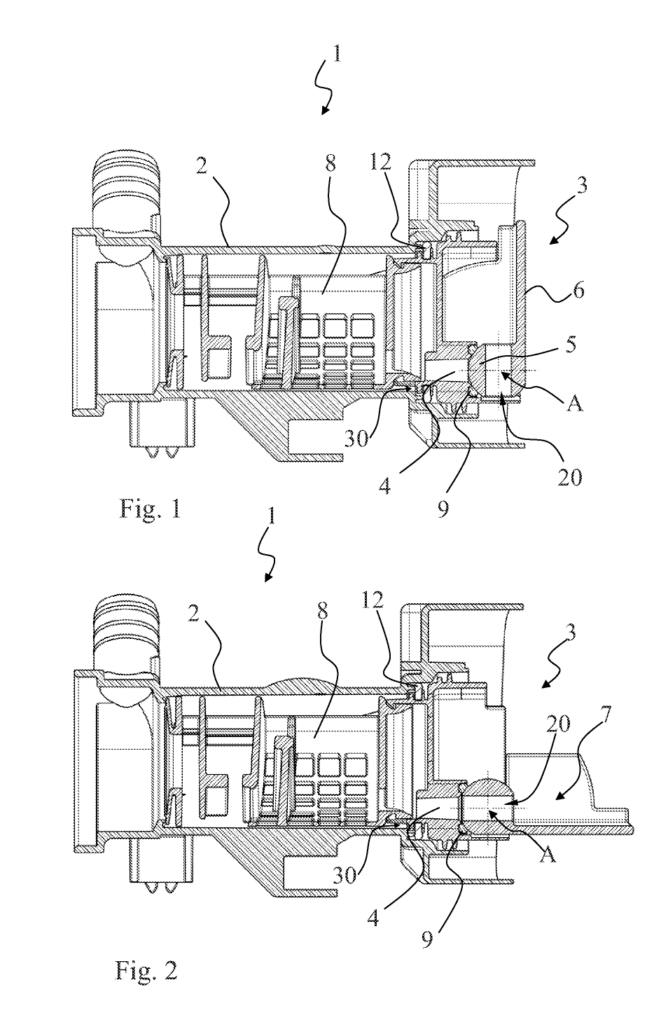

FIG. 1 depicts a filter unit 1 in cross-sectional side-view according to a first embodiment of the invention. The filter unit 1 comprises a body 2 for receiving therein a filter 8, e.g. a sieve and/or diaphragm, adapted for allowing the free passage of a liquid (i.e. water and water mixed with washing/rinsing products) and for trapping lint, fluff and other small objects (i.e. buttons, coins, etc) which may be contained in the liquid. The body 2 is provided with a filter opening 30, adapted for allowing the insertion/removal of the filter 8, and a service cap 3 is provided for selectively closing the filter opening 30.

Preferably, but not necessarily, a gasket 12 is arranged between cap 3 and body 2 to provide a seal between them. By turning the cap 3 the filter 8 can be removed from the body 2 to clean the filter 8 from any lint, fluffs or other small objects, e.g. coins.

In the embodiments illustrated in the enclosed figures, the cap 3 is fixed to the body 2, in a removable way, by screwing; in a further embodiment, not illustrated, the cap 3 may be fixed to the body 2 by another suitable removable coupling means, for example by a bayonet coupling.

In the embodiments illustrated in the enclosed figures, the cap 3 is attached to the filter 8 in a rotatable way, so that the cap 3 may freely rotate with respect to the filter 8.

In a further embodiment, not illustrated, the filter 8 and the cap 3 are integrally formed.

In a further embodiment thereof, also not illustrated, the cap 3 is separated from the filter 8 and the latter may be inserted in/removed by the body 2 after removing the cap 3 from the filter 2, so as to open the filter opening 30.

The cap 3 comprises a drain passage 4 which is closed, i.e. sealed, by a closing means, advantageously comprising a ball head 5 provided at the end of a swivel-mounted lever 6. The ball head 5 comprises a through hole 20. The through hole 20 is arranged in such a way that in the closed position of the lever 6 the through hole 20 doesn't fluidly communicate with the drain passage 4; in particular, in the embodiment illustrated in FIG. 1, in the closed position of the lever 6 the through hole 20 is substantially perpendicular to the longitudinal axis of the drain passage 4. Thereby the ball head 5 and its seat in the cap 3 form a ball valve adapted to selectively open or close the drain passage 4.

As shown in FIG. 2, the drain passage 4 of cap 3 is opened by simply pivoting the lever 6 about its pivot axis A located at the ball head 5. Thereby, the through hole 20 of the ball head 5 is aligned with the drain passage 4 and residual water is drained from the filter unit 1, i.e. from the household appliance into which the filter unit 1 is integrated. When the lever 6 is pivoted into its open position, the lever 6 additionally provides a drain channel 7 for guiding residual water away from the filter unit 1, for example into a vessel, not illustrated, placed by the user in front of the household appliance. Thereby the lever 6 provides a convenient and clean way for draining water from the filter unit 1 before the cap 3 is opened to clean the filter 8.

Preferably, but not necessarily, the drain passage 4 is arranged in such a way that when the cap 3 is fixed to the body 2 in its closing position, illustrated for example in FIG. 1, the drain passage 4 is positioned in proximity of the bottom of the body 2, so that substantially all the liquid present in the body 2 may flow through the drain passage 4 when the lever 6 is in its open position.

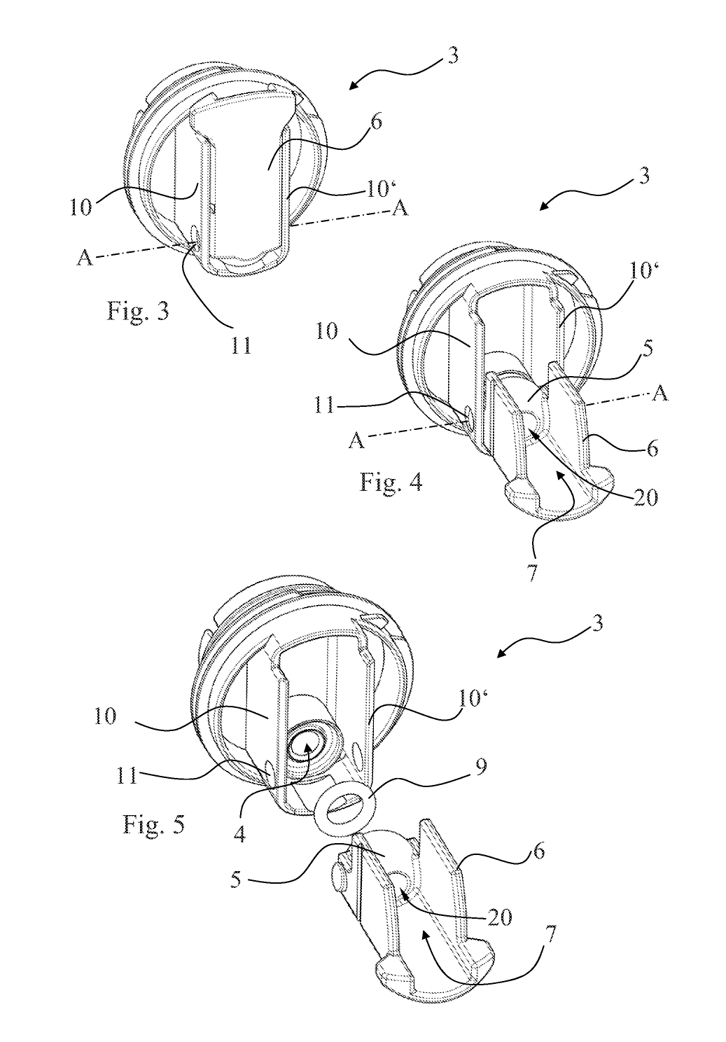

FIGS. 3 and 4 show a perspective view of the cap 3 of FIG. 1 in the closed and opened position of the lever 6, respectively. The lever 6 provides an effective and simple one-step draining of water from the filter unit 1 with a simple pivot-movement of the lever 6, i.e. a quarter-turn thereof, about its pivot axis A, i.e. its pivot bearing 11.

As shown in FIG. 4, in the open position lateral walls of the lever 6 provide the drain channel 7 for guiding water away from the filter unit 1. Further, the cap 3 comprises a handle in form of lateral wings 10, 10′ arranged laterally of the lever 6 and providing grip portions in its closed position (FIG. 3). The wings 10, 10′ form the handle for turning the cap 3 into an opened position, for removing the filter 8 from the body 2, and to turn the cap 3 to its closed position after inserting the filter 8 into the body 2 again. Alternatively—when no wings are provided (not shown)—the lever 6 in its closed position is operative as a handle to turn the cap 3.

FIG. 5 shows an exploded view of the cap 3 of the filter unit 1 of FIG. 1. Preferably, but not necessarily, a sealing means, for example an O-ring 9 is inserted into the valve seat at the outlet of the drain passage 4 in the cap 3 to provide a water-tight seal or contact between the ball head 5 and its valve seat in the cap 3.

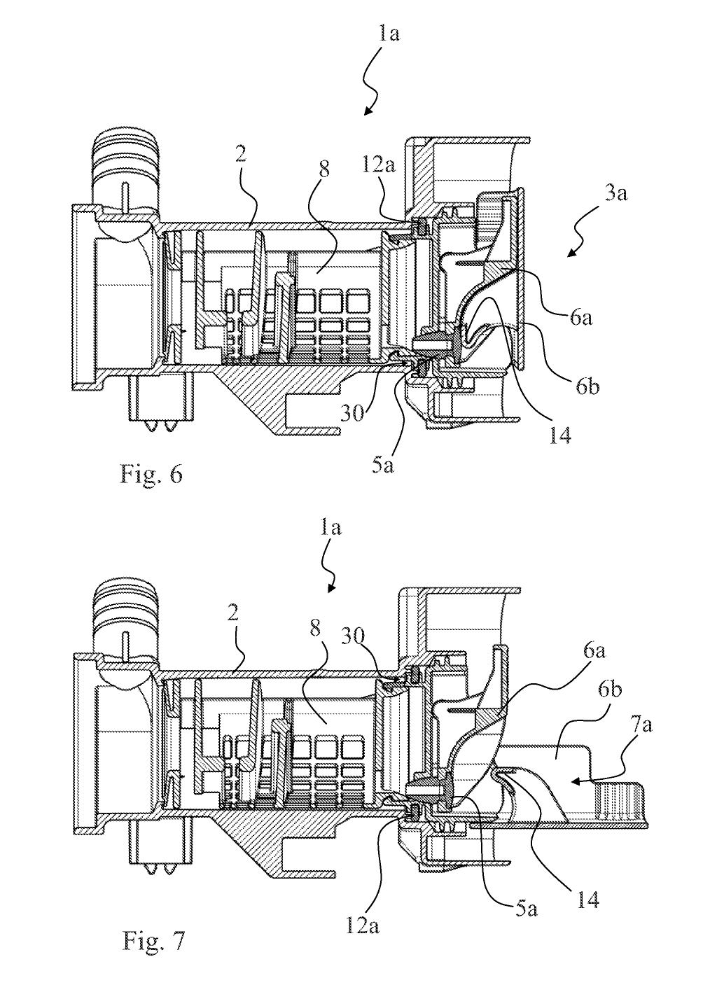

FIGS. 6 to 9 show a second embodiment of a filter unit 1a. Elements of the second embodiment corresponding to elements of the first embodiment are labeled with like reference numerals. Unless otherwise noted, elements of the filter unit 1 of FIGS. 1 to 5 correspond to elements of the filter unit 1a of FIGS. 6 to 9.

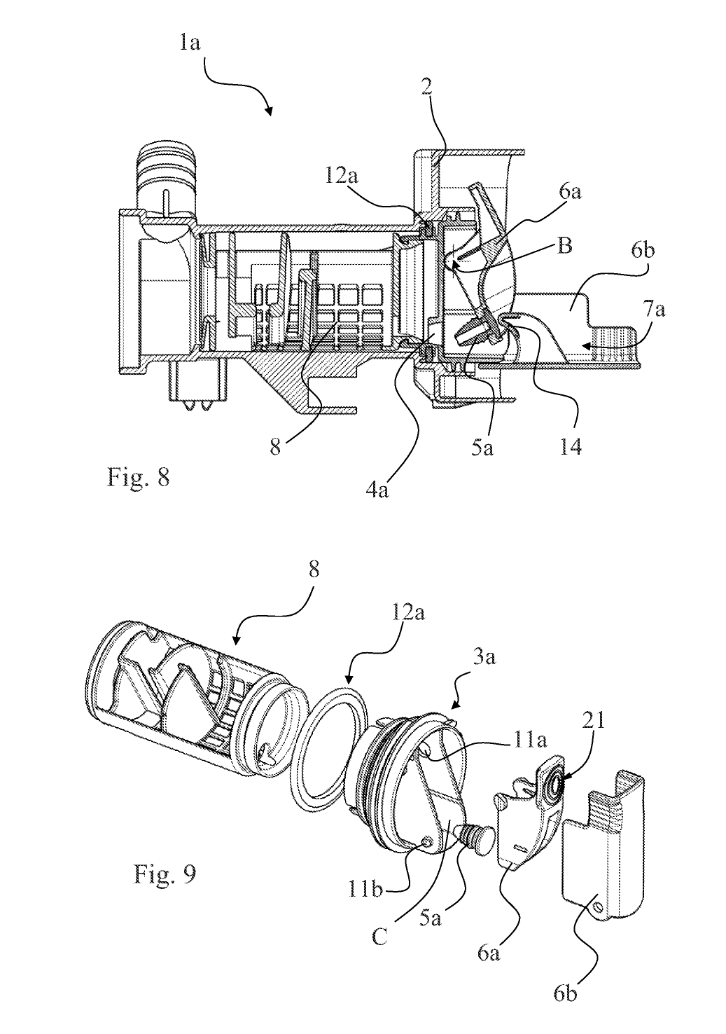

The filter unit 1a according to the second embodiment comprises a lever element 6a for opening and closing the drain passage 4a of the cap 3a (FIG. 8). The drain passage 4a in the cap 3a is closed, i.e. sealed, by closing means comprising a conical plug 5a arranged at the lower end of the lever element 6a for closing the drain passage 4a. Preferably the plug 5a is or comprises an elastic sealing material, e.g. rubber material, Viton, Teflon or the like.

In a further embodiment, not illustrated, the closing means comprises a cover plate or disc to close the outlet of the drain passage 4a in the cap 3a. Alternatively the closing means comprises a combination of a plug and a plate to provide a secure closing of the drain passage 4a in the cap 3a.

The pivot axis B of the lever element 6a is located in a middle section of the lever element 6a such that the user can operate (turn) the lever element 6a by pushing against the upper end of lever element opposite to the lever end where the plug 5a is mounted (FIG. 8). Advantageously, but not necessarily, a spring (not illustrated) may be provided, adapted for rotating the lever element 6a in such a way to press the conical plug 5 towards the drain passage 4a, so as to keep close the latter.

FIG. 9 depicts a circular pushing area 21 in the upper end of lever element 6a, indicated for the user for pressing in order to rotate the lever element 6a, so as to open the drain passage 4a. By this lever/plug remote operation users' hand is out of reach for the outflowing liquid.

The filter unit 1a further comprises a second lever element 6b which provides a drain channel 7a for guiding residual water away from the filter unit 1a and which locks/unlocks the lever element 6a in its closed position (see below).

The cross-sectional side-views of FIGS. 6 to 8 show the steps of opening the drain passage 4a in cap 3a. In a first step the second lever element 6b is pivoted about its axis, i.e. pivot bearing 11b, into an opened position (FIG. 6=closed position to FIG. 7=second lever 6b turned). Thereby the second lever element 6b provides a drain channel 7a for guiding water away from the filter unit 1a, in this respect similar to the drain channel 7 of the first embodiment. After the second lever element 6b is in its opened position, the drain passage 4a of the cap 3a can be opened by pushing the upper part of the lever element 6a (against the action of the spring, if the latter is present) such that the lever element 6a pivots about its pivot axis B, i.e. pivot bearing 11a. Thereby the plug 5a is swung away, i.e. removed from the drain passage 4a (FIG. 8). As the drain channel 7a is provided by the second lever element 6b before the drain passage 4a of the cap 3a is opened, draining of water can be precisely controlled by gradually opening the drain passage 4a with lever element 6a.

In its closed position, the second lever element 6b is operative as a handle or grip for opening and closing the cap 3a. Further, the second lever element 6b provides a lock for the lever element 6a via the lock head 14 (FIG. 6). The lock head 14 is arranged at the inside surface in the liquid channel 7a of the second lever element 6b. In this embodiment, the lock head 14 has the form of a nose-shaped protrusion with a rounded tip. When both lever elements 6a, 6b are in their closed position, a shoulder next to the tip of the lock head 14 abuts to the outer surface of plug 5a and presses it onto the drain passage 4a. Turning the second lever element 6b to the open position unlocks the plug 5a and thereby the lever end of lever element 6a such that it can be operated by the user. After the cleaned filter 8 is reinserted into the body 2 of unit 1a, drain passage 4a can be closed by plug 5a by rotating lever element 6a to the closed position and by swinging the second lever element 6b upward; in its closed position (FIG. 6) the second lever element 6b prevents an accidental activation of the lever element 6a as the shoulder next to the tip of the lock head 14 is close to the pivot axis C between the pivot bearings 11b of the second lever element 6b.

Alternatively, the drain passage 4a can be closed also by rotating the second lever element 6b upward even if the lever element 6a isn't yet in its closed position; in this case, when the second lever element 6b is swung upward, the tip of lock head 14 abuts to the plug 5a (FIG. 8) and guides it toward the drain passage 4a—thereby rotating lever element 6a to its closed position.

FIG. 9 shows an exploded view of the parts of the filter unit 1a which can be removed from the filter unit 1a for cleaning A gasket 12a is provided between filter 8 and cap 3a to achieve for the assembled filter unit 1a a seal between cap 3a and body 2. Further, the position of the pivot bearing 11a of the lever element 6a opposite to the position of the pivot bearing 11b of the second lever element 6b is shown.

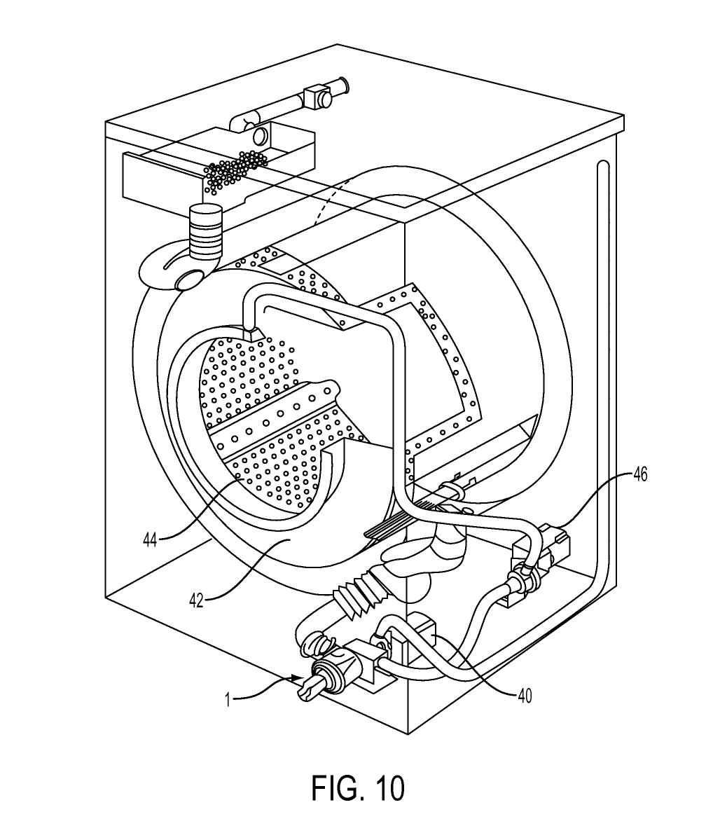

A filter unit 1 (1a or 1b) according to the invention may be used in a washing machine or in a washer-dryer, schematically depicted in FIG. 10, provided with a water outlet circuit advantageously comprising a drain pump 40 and some draining pipes adapted to drain, after the washing and rinsing phases, the washing/rinsing liquid (i.e. water and water mixed with washing and/or rinsing products) from a washing tub 42 containing a rotatable 44 drum in which the laundry to be washed is loaded. Optionally, as illustrated, the washing machine may include a liquid recirculating pump 46 and circuit for recirculating washing/rinsing liquid from the bottom to the top of the tub. In the illustrated case, the filter unit 1 is interposed between the washing tub 42 and the drain pump 40, in such a way that all the liquid exiting the washing tub has to pass through the filter element 8 before reaching the drain pump 40, so as to retain all undesirable bodies (for example buttons came off from the laundry, coins erroneously introduced into the washing machine, etc.) which could damage or obstruct the drain pump 40.

The invention has been described in terms of particular exemplary embodiments. Numerous other embodiments, modifications and variations within the scope and spirit of the appended claims will occur to persons of ordinary skill in the art from a review of this disclosure.

1. A filter unit for a washing machine, the filter unit comprising:
a filter receiving body,
a filter opening in the filter receiving body,
a cap for closing the filter opening,
a drain passage passing through the cap,
an openable closure for selectively opening and closing the drain passage; and
a swivel-mounted lever element in operative connection with the openable closure for opening and closing the same.

2. A filter unit according to claim 1, wherein the lever element comprises a drain channel.

3. A filter unit according to claim 1, wherein the lever element forms a handle element for the cap.

4. A filter unit according to claim 1, wherein the cap comprises a handle element at least partially enclosing the lever element.

5. A filter unit according to claim 1, wherein the openable closure is pivotably mounted.

6. A filter unit according to claim 1, further comprising a filter element adapted to be received in the filter receiving body, wherein the filter element is rotatably attachable to the cap.

7. A filter unit according to claim 1, further comprising a filter element adapted to be received in the filter receiving body, wherein the filter element and the cap are integrally formed.

8. A filter unit according to claim 1, wherein the openable closure forms a valve element in respect of the drain passage, said valve element comprising one of a ball valve element and a butterfly valve element.

9. A filter unit according to claim 1, wherein the openable closure further comprises a seal for sealing between the drain passage and the openable closure arranged at the cap.

10. A filter unit according to claim 1, wherein the openable closure is arranged at a lever end of the lever element.

11. A filter unit according to claim 10, wherein the openable closure comprises at least one of a plate to close the outlet of the drain passage, and a plug which is at least partially pluggable to the drain passage.

12. A filter unit according to claim 1, further comprising a second lever element operative as a lock element for the other lever element, wherein the second lever element comprises a drain channel.

13. A filter unit according to claim 12, wherein the second lever element comprises a lock head for locking at least one of the lever element and the openable closure in its closed position.

14. A filter unit according to claim 12, wherein the second lever element is operative as a handle for the cap.

15. A washing machine, having a filter unit according to claim 1 along a liquid flow path of the washing machine.

16. A washing machine according to claim 15, wherein said filter unit is interposed between a washing tub and a drain pump of the washing machine.
